(19) United States
(12) Patent Application Publication
(10) Pub. No.: US 2014/0103757 A1
(43) Pub. Date: Apr. 17, 2014

(54) ELECTRIC MACHINE HOUSING

(71) Applicant: Larry Kubes, Indianapolis, IN (US)

(72) Inventor: Larry Kubes, Indianapolis, IN (US)

(21) Appl. No.: 13/652,946

(22) Filed: Oct. 16, 2012

(51) Int. Cl. H02K 9/00

(52) U.S. Cl. 310/57; 310/64

(57) ABSTRACT

An electric machine housing including a base wall, an outer wall extending from the base wall to an outer cantilevered end, and an inner wall spaced from the outer wall forming an annular void. The inner wall extends from the base wall to an inner cantilevered end. A first plurality of ribs extend within the annular void from the base wall toward the outer and inner cantilevered ends. A second plurality of ribs is arranged within the annular void spaced from the first plurality of ribs. The second plurality of ribs extend from the outer and inner cantilevered ends toward the base wall. The first and second pluralities of ribs define a tortuous flow path within the annular void.

### BACKGROUND OF THE INVENTION

Exemplary embodiments pertain to the art of electric machines and, more particularly, to an electric machine housing.

Electric machines generally include a housing that encloses a rotor and a stator. The rotor typically includes a rotor hub. The rotor hub supports a plurality of rotor windings that, when acted upon by a magnetic field generated by the stator, cause the rotor to rotate. In some cases, the rotor will include laminations that support permanent magnets. The permanent magnets also interact with the magnetic field supplied by the stator causing the rotor to rotate. The rotor hub is joined to a shaft that is supported by one or more bearings. In some cases, a coolant is introduced into the housing to exchange heat with the rotor, stator and/or other internal components. In other cases, the coolant is introduced into a jacket that is mounted to an external surface of the housing.

### BRIEF DESCRIPTION OF THE INVENTION

Disclosed is an electric machine housing including a base wall, an outer wall extending from the base wall to an outer cantilevered end, and an inner wall spaced from the outer wall forming an annular void. The inner wall extends from the base wall to an inner cantilevered end. A first plurality of ribs extend within the annular void from the base wall toward the outer and inner cantilevered ends. A second plurality of ribs is arranged within the annular void spaced from the first plurality of ribs. The second plurality of ribs extend from the outer and inner cantilevered ends toward the base wall. The first and second pluralities of ribs define a tortuous flow path within the annular void.

Also disclosed is an electric machine housing including a base wall, an outer wall extending from the base wall to an outer cantilevered end, and an inner wall spaced from the outer wall forming an annular void. The inner wall extends from the base wall to an inner cantilevered end. A seal ring is positioned in the annular void at the outer and inner cantilevered ends. The seal ring is configured and disposed to substantially prevent coolant from passing from the annular void at the outer and inner cantilevered ends.

Further disclosed is an electric machine housing including a base wall, an outer wall extending from the base wall to an outer cantilevered end, and an inner wall spaced from the outer wall forming an annular void. The inner wall extends from the base wall to an inner cantilevered end. The base wall, outer wall and inner wall are integrally formed. A first plurality of ribs extend within the annular void from the base wall toward the outer and inner cantilevered ends. A second plurality of ribs is arranged within the annular void spaced from the first plurality of ribs. The second plurality of ribs extend from the outer and inner cantilevered ends toward the base wall. The first and second pluralities of ribs define a tortuous flow path within the annular void. A seal ring is positioned in the annular void at the outer and inner cantilevered ends. The seal ring is configured and disposed to substantially prevent coolant from passing from the annular void at the outer and inner cantilevered ends.

### BRIEF DESCRIPTION OF THE DRAWINGS

The following descriptions should not be considered limiting in any way. With reference to the accompanying drawings, like elements are numbered alike:

FIG. 1 depicts a partial cross-sectional view of an electric machine having an electric machine housing in accordance with an exemplary embodiment;

FIG. 2 depicts a partial perspective view of the electric machine housing of FIG. 1;

FIG. 3 depicts a cross-sectional side view of the electric machine housing in accordance with an aspect of the exemplary embodiment;

FIG. 4 depicts a cross-sectional side view of the electric machine housing in accordance with another aspect of the exemplary embodiment; and

FIG. 5 is a perspective view of the electric machine housing illustrating a seal ring in accordance with an exemplary embodiment.

### DETAILED DESCRIPTION OF THE INVENTION

A detailed description of one or more embodiments of the disclosed apparatus and method are presented herein by way of exemplification and not limitation with reference to the Figures.

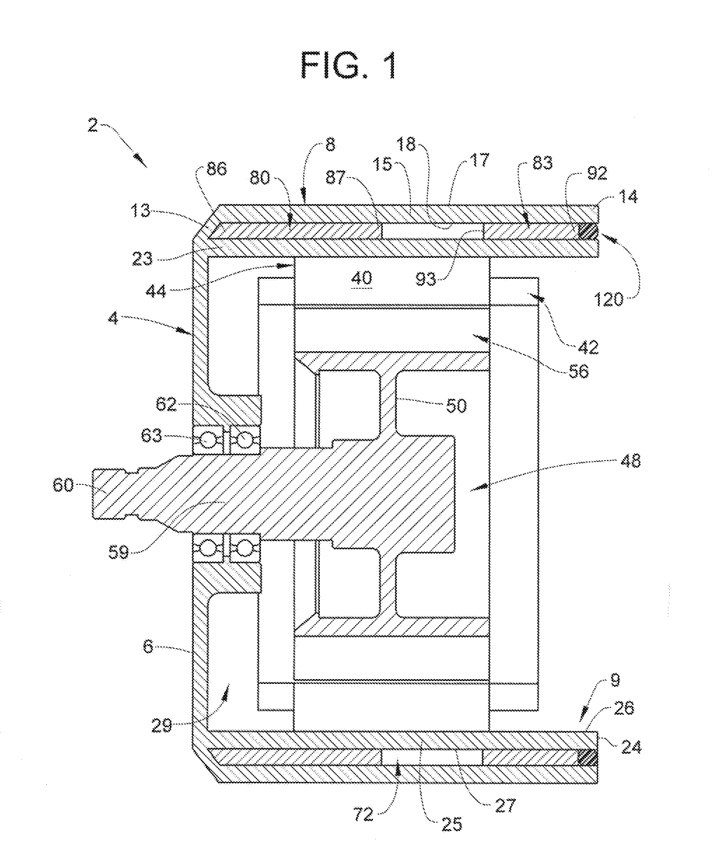

An electric machine constructed in accordance with an exemplary embodiment is indicated generally at 2 in FIG. 1. Electric machine 2 includes an electric machine housing 4 having a base wall 6, an outer wall 8 and an inner wall 9. Outer wall 8 and inner wall 9 extend from base wall 6 and possess a generally circular cross-section. Of course, it should be understood, that outer wall 8 and inner wall 9 may possess various geometries and should not be considered as being limited to being circular. In accordance with an aspect of the exemplary embodiment, base wall 6, outer wall 8, and inner wall 9 are materially integrally formed. In accordance with another aspect of the exemplary embodiment, base wall 6, outer wall 8, and inner wall 9 are joined one to another to form electric machine housing 4.

Outer wall 8 includes a first end 13 that extends from base wall 6 to a second, cantilevered, end 14 through an intermediate portion 15. Intermediate portion 15 includes a first surface 17 and an opposing second surface 18. First surface 17 represents an exterior surface of electric machine housing 4. Inner wall 9 includes a first end 23 that extends from base wall 6 to a second, cantilevered, end 24 through an intermediate portion 25. Intermediate portion 25 includes a first surface portion 26 and an opposing second surface portion 27. First surface portion 26 defines an interior portion 29 of electric machine housing 4. Electric machine housing 4 also generally includes an end wall (not shown) that extends across interior portion 29 and connects with one, the other, or both cantilevered ends 14 and 24 of outer and inner walls 8 and 9 respectively. Of course, it should be understood that electric machine housing 4 may also be devoid of an end wall.

Electric machine 2 includes a stator 40 mounted to first surface portion 26 of inner wall 9. Stator 40 includes a plurality of stator windings 42 that are supported by a stator core 44. A rotor 48 is rotatably mounted within interior portion 29. Rotor 48 includes a rotor hub 50 that supports rotor windings or laminations 56. Rotor hub 50 is coupled to a shaft 59 having an end 60 that is rotatably supported relative to electric machine housing 4 through a first bearing 62 and a second bearing 63. At this point it should be understood that while shown with a single end supported to electric machine housing 4, shaft 59 could also include another end supported at an opposing end wall (not shown).

In accordance with an exemplary embodiment, electric machine housing 4 includes an annular void 72 defined between outer wall 8 and inner wall 9. Annular void 72 provides a coolant channel that receives and directs a coolant flow about electric machine housing 4 to absorb heat produced by stator 40 and rotor 48. Annular void 72 is provided with a first plurality of ribs 80 and a second plurality of ribs 83. Ribs 80 and 83 act as obstacles in annular void 72. More specifically, ribs 80 and 83 enhance heat transfer between the coolant and electric machine housing 4.

In accordance with one aspect of the exemplary embodiment, first plurality of ribs 80 include a non-circular cross-section and are materially integrally formed with electric machine housing 4 while second plurality of ribs 83 include a generally circular cross-section and are inserted into annular void 72 as will be detailed more fully below. Each of the first plurality of ribs 80 includes a first end 86 that extends to a second end 87. Likewise, each of the second plurality of ribs 83 includes a first end section 92 that extends to a second end section 93. The first and second pluralities of ribs 80 and 83 are formed from a heat conducting material such as steel, aluminum or alloys thereof Of course, it should be understood that the second plurality of ribs 83 may also be formed from plastic. In accordance with one aspect of the exemplary embodiment, first end 86 of ribs 80 is spaced from first end section 92 of ribs 83.

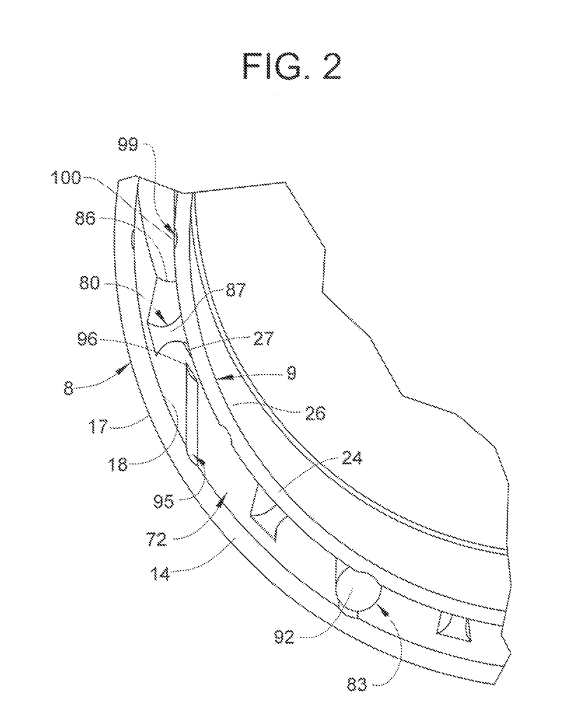

The second plurality of ribs 83 is inserted between outer wall 8 and inner wall 9 as shown in FIG. 2. More specifically, outer wall 8 includes a first plurality of recesses 95 having a first base section 96. Similarly, inner wall 9 includes a second plurality of recesses 99 having a second base section 100. Recesses 95 and 99 may be formed by guiding a cutting tool, such as a drill, between outer wall 8 and inner wall 9. Accordingly, each recess 95 registers with a corresponding one of recess 99 to form rib receiving zones (not separately labeled) that are configured to receive ribs 83. It should be understood that ribs 83 may also be press-fit between outer wall 8 and inner wall 9 without the need for recesses.

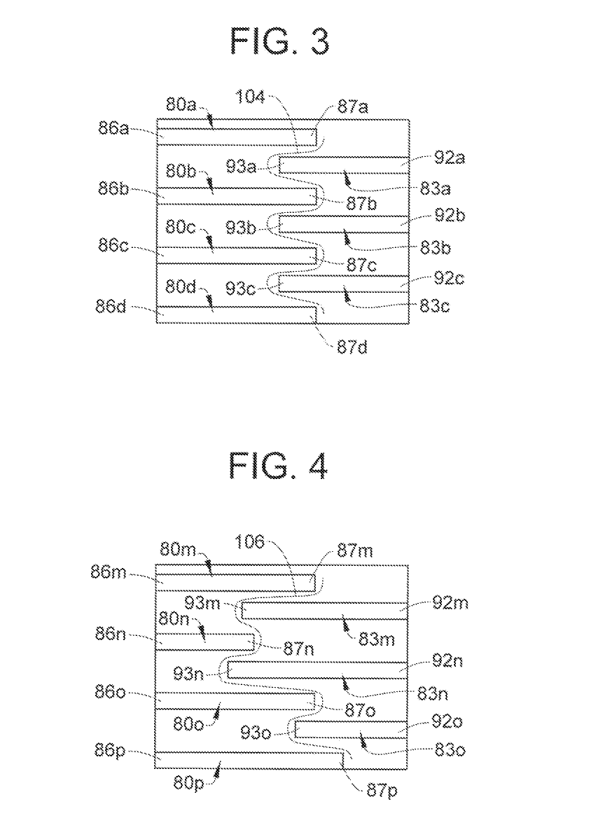

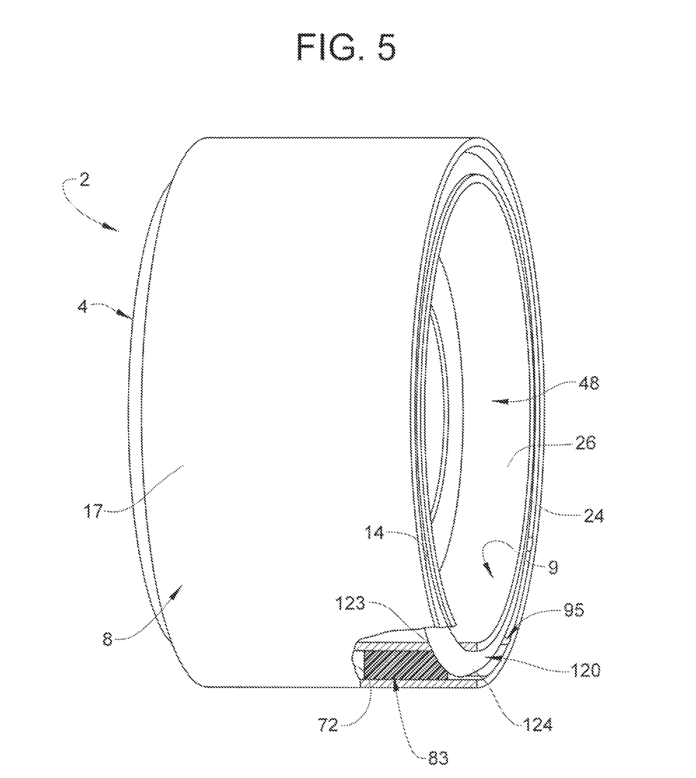

FIG. 3 illustrates an aspect of the exemplary embodiment in which a first plurality of ribs 80a-80d include a first length defined between corresponding ones of first ends 86a-86d and second ends 87a-87d; and a second plurality of ribs 83a-83c include a second length defined between corresponding ones of first end sections 92a-92b and second end sections 93a-93c. The first length and the second length may be substantially similar. The first length and the second length may also be different. As shown, second ends 87a-87d of ribs 80a-80d extend beyond second end sections 93a-93c of ribs 87a-87d to form a tortuous coolant flow path 104.

FIG. 4 illustrates another aspect of the exemplary embodiment in which a first plurality of ribs 80m-80p include a first length defined between corresponding ones of first ends 86m-86p and second ends 87m-87p; and each of the second plurality of ribs 83m-83o include a second length defined between corresponding ones of first and second end sections 92m-92o and 93m-93o. The first lengths of the first plurality of ribs 80m-80o differ from one another. Likewise the second lengths of the second plurality of ribs 83m-83o differ from one another. As shown, second ends 87m-87p of ribs 80m-80p extend beyond second end sections 93m-93o of ribs 83m-83o to form a tortuous coolant flow path 106. Of course, it should be understood that two or more of the first lengths and two or more of the second lengths may be similar.

Electric machine housing 4 also includes a seal ring 120 arranged between outer wall 8 and inner wall 9 at cantilevered ends 14 and 24. Seal ring 120 may be formed from a metal, a plastic material, or a composite material and includes a first end portion 123 that extends to a second end portion 124. First end portion 123 may be joined to second end portion 124 using a variety of techniques including metallurgical bonds, such as welding, and chemical bonds, such as epoxy. Seal ring 120 may also be formed as a seamless materially integral component. Seal ring 120 may be held in place to electric machine housing 4 through a metallurgical bond such as welding, a chemical bond, such as epoxy, or through a mechanical bond such as by rolling one, the other, or both of cantilevered ends 14 and 24, press or interference fitting or the like. Seal ring 120 is configured and disposed to substantially prevent coolant from exiting annular void 72.

At this point it should be understood that the exemplary embodiments describe an electric machine housing having outer and inner walls spaced from one another to form an annular void. The annular void is provided with obstacles, described as first and second pluralities of ribs, that enhance heat transfer between a coolant and other components of the electric machine. It should be understood that while the first plurality of ribs are described as being materially integrally formed with electric machine housing, they may also be separately formed and mounted in the annular void. It should also be understood that the shape of the annular void may vary depending on an overall geometry of the electric machine. In the present case, the void is described as being annular as the electric machine possesses a generally circular cross-section. It should also be understood that the number, arrangement, shape and materials used to form the first and second plurality of ribs may vary. Likewise the seal ring may be formed from a variety of materials and joined to the electric machine housing using a variety of techniques. Finally it should be understood that while shown as an open ended electric machine, a cover may be provided across the cantilevered end.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. An electric machine housing comprising:
a base wall, an outer wall extending from the base wall to an outer cantilevered end, and an inner wall spaced from the outer wall forming an annular void, the inner wall extending from the base wall to an inner cantilevered end;
a first plurality of ribs extending within the annular void from the base wall toward the outer and inner cantilevered ends; and
a second plurality of ribs arranged within the annular void spaced from the first plurality of ribs, the second plurality of ribs extending from the outer and inner cantilevered ends toward the base wall, the first and second pluralities of ribs defining a tortuous flow path within the annular void.

2. The electric machine housing according to claim 1, wherein the first plurality of ribs are integrally formed with one or more of the base wall, the outer wall, and the inner wall.

3. The electric machine housing according to claim 1, wherein each of the first plurality of ribs includes a first end extending from the base wall to a second end, the second end being spaced from the outer cantilevered end and the inner cantilevered end.

4. The electric machine according to claim 3, wherein each of the second plurality of ribs includes a first end that extends to a second end, the second end of one or more of the second plurality of ribs extending beyond the second end of one or more of the first plurality of ribs.

5. The electric machine according to claim 1, wherein the outer wall includes a surface having a first plurality of recesses and the inner wall includes a surface having a second plurality of recesses, the first plurality of recesses registering with the second plurality of recesses forming a plurality of rib receiving zones.

6. The electric machine according to claim 5, wherein each of the second plurality of ribs are arranged in respective ones of the plurality of rib receiving zones.

7. The electric machine according to claim 5, wherein each of the first plurality of recesses includes a first base section spaced from the base wall and each of the second plurality of recesses includes a second base section spaced from the base wall.

8. The electric machine according to claim 7, wherein each of the second plurality of ribs includes a first end section that extends to a second end section, the first end section being spaced from the outer and inner cantilevered ends and the second end section abutting the first and second base sections in respective ones of the plurality of rib receiving zones.

9. The electric machine according to claim 1, wherein the second plurality of ribs includes one or more ribs having a first length and one or more ribs having a second length, the first length being distinct from the second length.

10. The electric machine according to claim 1, wherein each of the second plurality of ribs are formed from a heat conducting material.

11. The electric machine according to claim 10, wherein the heat conducing material includes one of aluminum and steel.

12. The electric machine according to claim 1, wherein each of the second plurality of ribs is formed from a plastic.

13. The electric machine according to claim 1, wherein each of the first plurality of ribs includes a generally non-circular cross-section.

14. The electric machine according to claim 1, wherein each of the second plurality of ribs includes a generally circular cross-section.

15. An electric machine housing comprising:
a base wall, an outer wall extending from the base wall to an outer cantilevered end, and an inner wall spaced from the outer wall forming an annular void, the inner wall extending from the base wall to an inner cantilevered end; and
a seal ring positioned in the annular void at the outer and inner cantilevered ends, the seal ring being configured and disposed to substantially prevent coolant from passing from the annular void at the outer and inner cantilevered ends.

16. The electric machine according to claim 15, wherein the seal ring includes a first end portion that extends toward a second end portion.

17. The electric machine according to claim 16, wherein the first end portion is joined to the second end portion.

18. The electric machine according to claim 17, wherein the second end portion is joined to the first end portion through one of a metallurgical bond and a chemical bond.

19. The electric machine according to claim 15, wherein the seal ring is secured to each of the outer wall and the inner wall in the annular void.

20. An electric machine housing comprising:
a base wall, an outer wall extending from the base wall to an outer cantilevered end, and an inner wall spaced from the outer wall forming an annular void, the inner wall extending from the base wall to an inner cantilevered end, the base wall, outer wall and inner wall being integrally formed;
a first plurality of ribs extending within the annular void from the base wall toward the outer and inner cantilevered ends;
a second plurality of ribs arranged within the annular void spaced from the first plurality of ribs, the second plurality of ribs extending from the outer and inner cantilevered ends toward the base wall, the first and second pluralities of ribs defining a tortuous flow path within the annular void; and
a seal ring positioned in the annular void at the outer and inner cantilevered ends, the seal ring being configured and disposed to substantially prevent coolant from passing from the annular void at the outer and inner cantilevered ends.
